(19) United States
(12) Patent Application Publication
(10) Pub. No.: US 2002/0084664 A1
(43) Pub. Date: Jul. 4, 2002

(54) Right-angle drive for slide out room

(76) Inventors: Patrick W. McManus, Osceola, IN (US); Martin P. McManus, Mishawaka, IN (US)

Correspondence Address: BAKER & DANIELS, 205 W. JEFFERSON BOULEVARD, SUITE 250, SOUTH BEND, IN, 46601, US

(21) Appl. No.: 10/002,336

(22) Filed: Oct. 24, 2001

Related U.S. Application Data
(60) Provisional application No. 60/242,966, filed on Oct. 24, 2000.

(51) Int. Cl. B62C 1/06

(52) U.S. Cl. 296/26.13

(57) ABSTRACT

A drive unit for a recreational vehicle slide out room comprises actuation members having linear gears fixed thereto. A drive mechanism is comprised of a transverse mounted unit having a fluid operated cylinder which drives an externally threaded rod. The externally threaded rod is cooperable with an internally threaded drive gear, which in turn meshes with a drive gear mounted to a transverse drive shaft. The transverse drive shaft has gears mounted at opposite ends which mesh with the linear gear teeth.

### FIELD OF THE INVENTION

This invention relates generally to a drive mechanism for driving a slide out room of mobile living quarters, such as a recreational vehicle, between a retracted position within the vehicle and an extended position laterally offset from the vehicle, and more particularly, to a drive mechanism wherein a cylinder for driving the room is situated and moves in a direction perpendicular to the direction of movement of the room.

### BACKGROUND OF THE INVENTION

The width of mobile living quarters, such as recreational vehicles, is limited to that which may be accommodated for travel on the highways. Accordingly, many vehicles are provided with slide out rooms which are retracted into the vehicle during travel, and extended from the vehicle to enlarge the living area of the vehicle when the vehicle is parked.

Conventional slide out rooms are typically supported by extendable supports which include telescoping tubes. Each support includes an outer tube mounted to the frame of the vehicle, and an inner tube retractable within the outer tube and connected to the slide out room. Typically, a pair of parallel supports are used, one for supporting each side of the room. The power for extending and retracting the room is typically supplied by an extendable cylinder referred to as a hydraulic ram. The cylinder is disposed between the supports and in parallel relationship thereto. The cylinder of the hydraulic ram is typically connected to the vehicle frame, and the piston is connected to the room. Accordingly, as the piston is extended from the cylinder, it forces the room outwardly. The weight of the room is carried by the extendable supports as the room is cantilevered out from the vehicle. Similarly, when the piston is retracted, the vehicle is returned to the retracted position.

The positioning of the hydraulic ram between the extendable supports and under the floor of the vehicle may interfere with other vehicle structures, such as cargo storage containers and liquid storage tanks. Accordingly, vehicle manufacturers must accommodate this obstruction of otherwise usable space.

### SUMMARY OF THE INVENTION

The present invention provides a drive mechanism for a slide out room which employs an extendable hydraulic cylinder mounted perpendicular to the extendable supports. The hydraulic cylinder extends and retracts a threaded drive rod which rotates a correspondingly threaded drive gear. The drive gear rotates a mating gear mounted to a shaft extending between the extendable supports. Rotation of the mating gear rotates the shaft which rotates a pair of pinions mounted at the ends of the shaft. The pinions are aligned with racks mounted to a lower surface of the inner tubes of the extendable supports. Accordingly, rotation of the pinions extends and retracts the inner tubes to move the slide out room between the extended and retracted positions.

In another embodiment of the invention, the hydraulic cylinder is mounted perpendicular to the extendable supports, but not between the supports. Instead, the cylinder extends perpendicularly from one of the supports. The cylinder of the alternate embodiment drives a piston connected to an internally threaded nut. As the nut extends and retracts, it rotates a correspondingly threaded drive rod which is connected at one end to a drive gear which also rotates. The drive gear is mounted to engage and rotate the pinion associated with the adjacent extendable support. Rotation of this pinion is translated through a shaft extending to a pinion associated with the other extendable support. Thus, rotation of the pinions drives the racks connected to the inner tubes of the extendable supports, thereby moving the room between the extended and retracted positions.

In yet another embodiment of the invention, the below frame extendable supports are replaced by a single rack mounted to the lower surface of the room floor. The room is guided for movement between the extended and retracted positions by a guide which is mounted to the upper surface of the vehicle floor and receives the rack. The cylinder rotates a pinion mounted within the guide by extending either a threaded rod into a correspondingly threaded opening in the pinion, or extending an internally threaded nut onto a correspondingly threaded rod connected to the pinion, thereby moving the room between the extended and retracted positions.

These and other advantages of the invention will be more apparent and the invention better understood by reference to the following detailed description in conjunction with the accompanying drawings.

### BRIEF DESCRIPTION OF THE DRAWINGS

FIG. 1 is perspective view of a vehicle having a slide out room and a drive mechanism according to the present invention;

FIG. 2 is a partially fragmented, perspective view of a drive mechanism according to the present invention;

FIG. 3 is a partially fragmented, perspective view of another embodiment of a drive mechanism according to the present invention;

FIG. 4 is a partially fragmented, exploded, perspective view of various components of the drive mechanism of the present invention;

FIG. 5 is a partially fragmented, side elevational view of various components of the present invention;

FIG. 6 is a perspective view of a vehicle having a slide out room and an alternate embodiment of a drive mechanism according to the present invention;

FIG. 7 is a perspective view of an alternate embodiment of a drive mechanism according to the present invention;

FIG. 8 is a partially fragmented, side elevational view of an alternate embodiment of the drive mechanism according to the present invention shown with a room in a retracted position;

FIG. 9 is a view similar to FIG. 8 with the room shown in an extended position;

FIG. 10 is a perspective view of the drive mechanism shown in FIGS. 8 and 9; and

FIG. 11 is a partially fragmented, exploded, perspective view of various components of the drive mechanism of FIGS. 8-10.

### DETAILED DESCRIPTION OF EMBODIMENTS OF THE INVENTION

The embodiments of the invention described herein are not intended to be exhaustive or to limit the invention to the precise forms disclosed. Rather, the embodiments selected for description have been chosen to enable one skilled in the art to practice the invention.

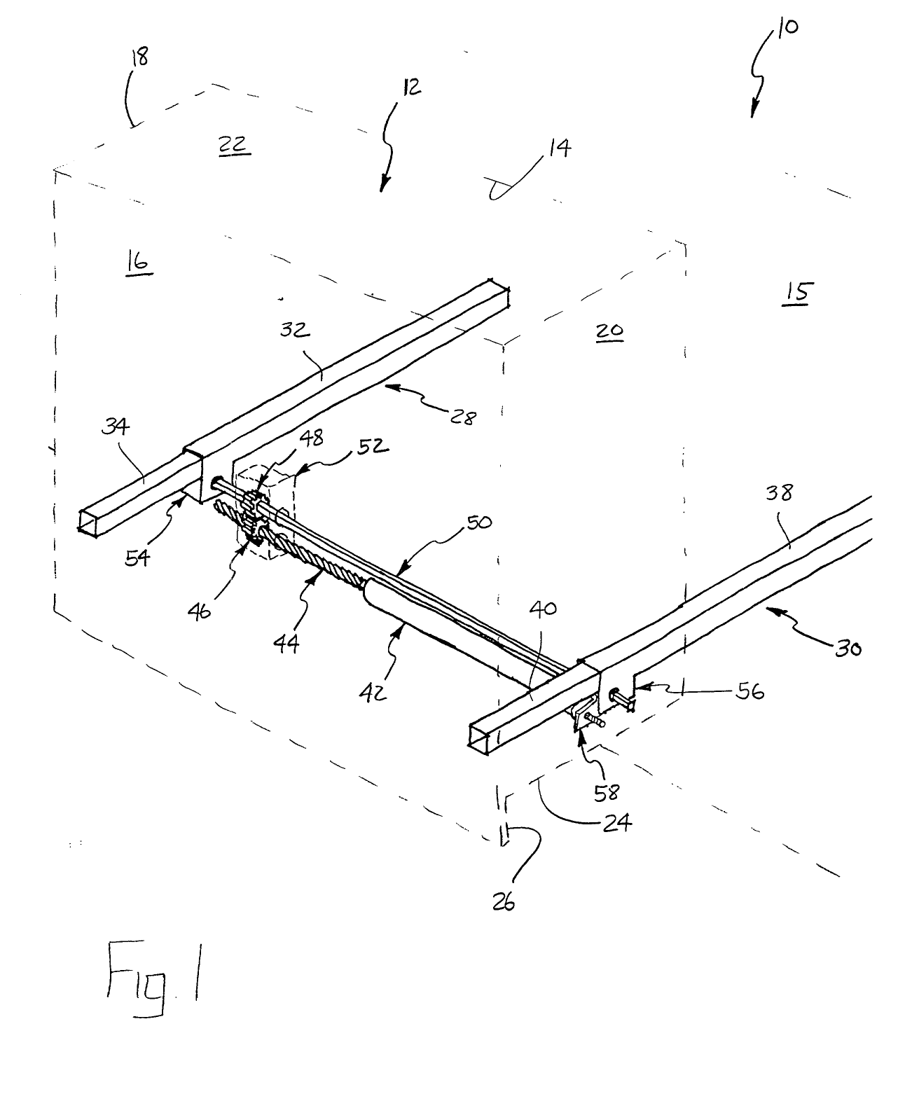

FIG. 1 shows a vehicle 10 having a slide out room 12 which is movable between an extended position (as shown in FIG. 1) extended laterally outwardly from vehicle 10, and a retracted position retracted within vehicle 10 through opening 14 formed vehicle side wall 15. Slide out room 12 includes a back wall 16, a pair of side walls 18, 20, a ceiling 22, a floor 24, and a fascia 26 which extends from back wall 16 below room floor 24.

A pair of extendable supports 28, 30 are mounted below vehicle 10. Extendable support 28 generally includes an outer, rectangular tube 32 and an inner, rectangular tube 34 which moves telescopically into and out of outer tube 32. Extendable support 30 likewise includes an outer tube 38 and an inner tube 40. Outer tubes 32, 38 are mounted to the vehicle frame (not shown) in a conventional manner. Inner tubes 34, 40 are connected to fascia 26 of room 12 using any one of a variety of connection methods.

The present invention generally includes a drive cylinder 42, a drive rod 44, a drive gear 46, and a mating gear 48 mounted to a shaft 50 extending between extendable supports 28, 30. Drive gear 46 and mating gear 48 are mounted within a drive housing 52 through which both drive rod 44 and shaft 50 extend, as will be further described below. Shaft 50 extends into a gear housing 54 connected to outer tube 32 of extendable support 28 and a gear housing 56 connected to outer tube 38 of extendable support 30. Drive cylinder 42 is mounted to gear housing 56 by a bracket 58 as will be further described below.

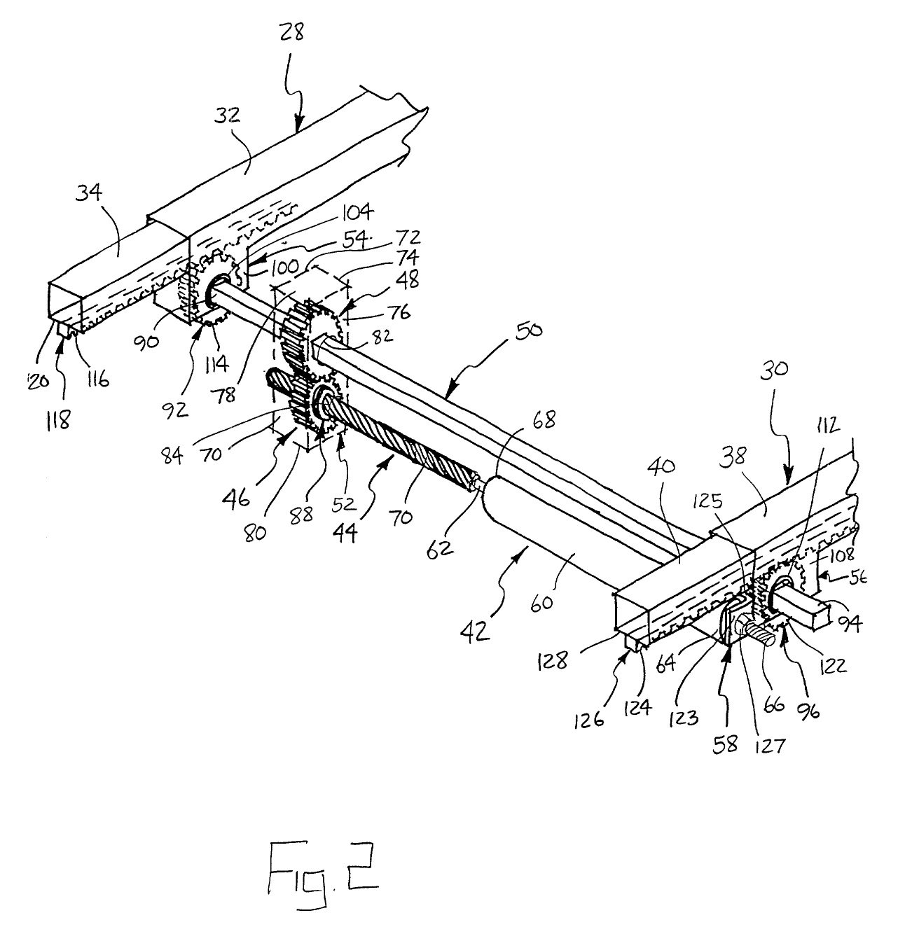

Referring now to FIG. 2, drive cylinder 42 includes a cylindrical housing 60 which is connected to a pair of hydraulic lines (not shown) for extending and retracting a piston 62 according to principles commonly known in the art. Piston 62 is fixedly connected to drive rod 44. Cylindrical housing 60 includes a first end 64 from which extends a threaded post 66 and a second end 68 through which extends piston 62.

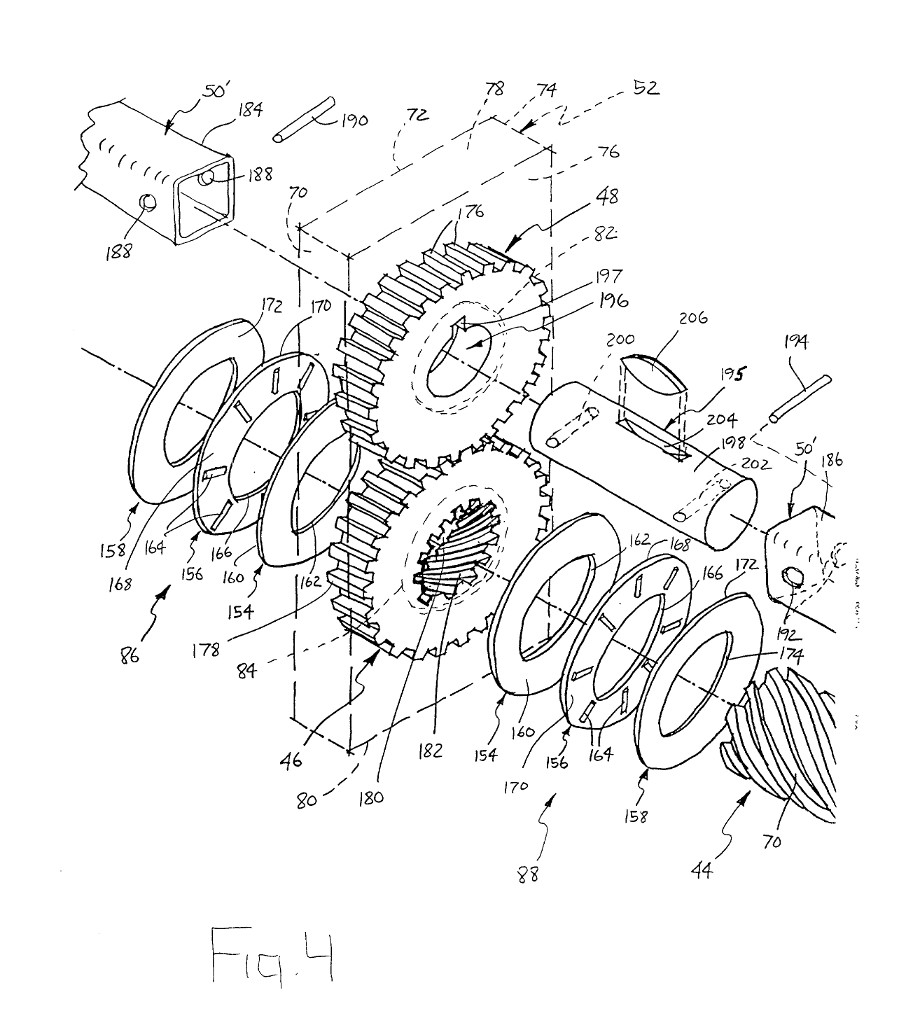

Drive rod 44 includes a plurality of high lead threads 70 and moves without rotating toward and away from drive housing 52 as piston 62 is extended and retracted. Drive housing 52 includes four side walls 70, 72, 74, 76, an upper wall 78, and a lower wall 80. A pair of openings 82, 84 (FIG. 4) are formed in both side walls 72, 76 for receiving shaft 50 and drive rod 44, respectively. Drive gear 46 and mating gear 48 are mounted for rotation with drive housing 52. A pair of thrust bearings 86, 88 (one shown) are mounted within drive housing 52 adjacent drive gear 46 to assist in translating the linear motion of drive rod 44 into the rotational motion of drive gear 46 as will be further described below.

Shaft 50 extends between extendable supports 28, 30 and includes a first end 90 connected to a pinion 92 mounted for rotation within gear housing 54 and a second 94 connected to a pinion 96 mounted for rotation within gear housing 56. Gear housing 54 includes a pair of opposed side walls 98, 100 (one shown) each having an opening 102, 104 (one shown) for receiving shaft 50. Gear housing 56 similarly includes a pair of opposed side walls 106, 108 (one shown) each having an opening 110, 112 (one shown) for receiving shaft 50.

Pinion 92 includes a plurality of teeth 114 which mesh with corresponding teeth 116 formed on a rack 118 which is mounted to a lower surface 120 of inner tube 34. Similarly, pinion 96 includes a plurality of teeth 122 which mesh with teeth 124 formed on a rack 126 which is mounted to a lower surface 128 of inner tube 40.

Bracket 58 which supports drive cylinder 42 includes a first portion 123 and a second portion 125. First portion 123 includes an opening (not shown) for receiving threaded post 66 of drive cylinder 42. Second portion 125 is mounted to gear housing 56 by welding or some other conventional mounting technique. A nut 127 is threaded onto threaded post 66 to secure drive cylinder 42 to bracket 58.

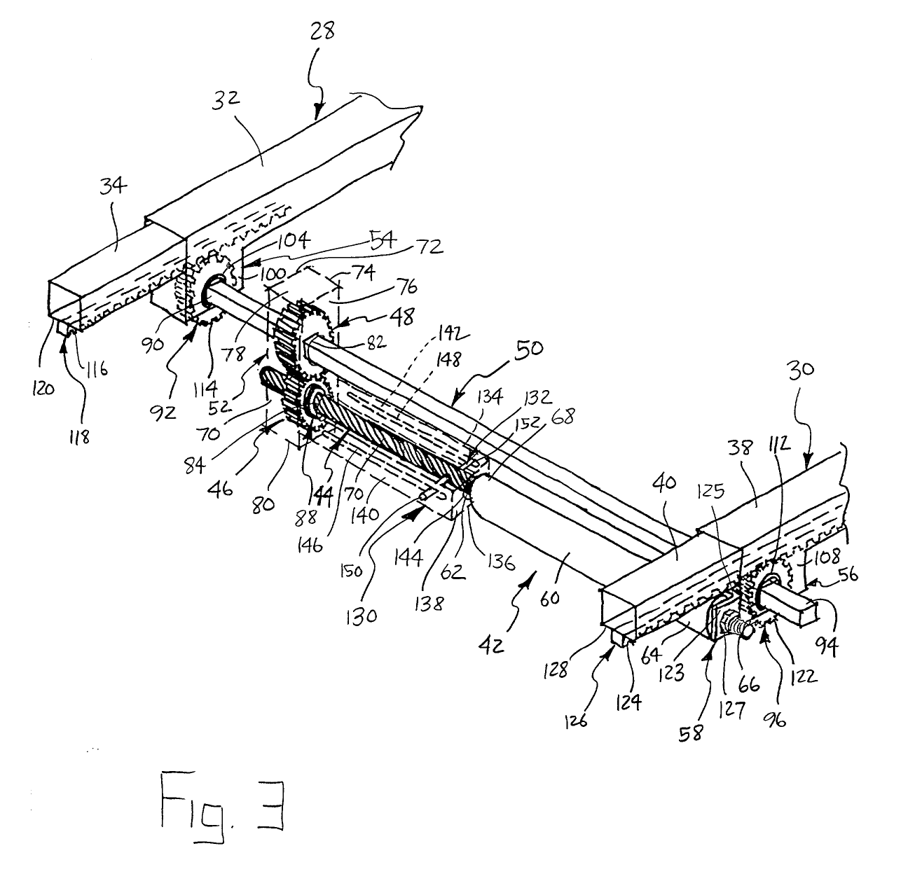

FIG. 3 shows a drive mechanism which is identical to that shown in FIG. 2 except for the addition of a guide housing 130 and an anti-rotation bar 132. Guide housing 130 is connected to drive housing 52 at side wall 76. Guide housing 130 includes an upper wall 134, a lower wall 136, an end wall 138, and a pair of side walls 140, 142. End wall 138 includes an opening 144 for receiving piston 62 of drive cylinder 42. Side walls 140, 142 include a pair of elongated slots 146, 148, respectively, which extend along the side walls in the direction of movement of drive rod 44. Anti-rotation bar 132 is fixedly connected to and extends through drive rod 44 as shown. A first end 150 of anti-rotation bar 132 extends through slot 146, and a second end 152 of anti-rotation bar 132 extends through slot 148. As drive rod 44 extends through and transmits force to drive gear 46, as will be further explained below, anti-rotation bar 132 slides within slots 146, 148 to further support and prevent rotation of drive rod 44 which is fixedly connected to piston 62.

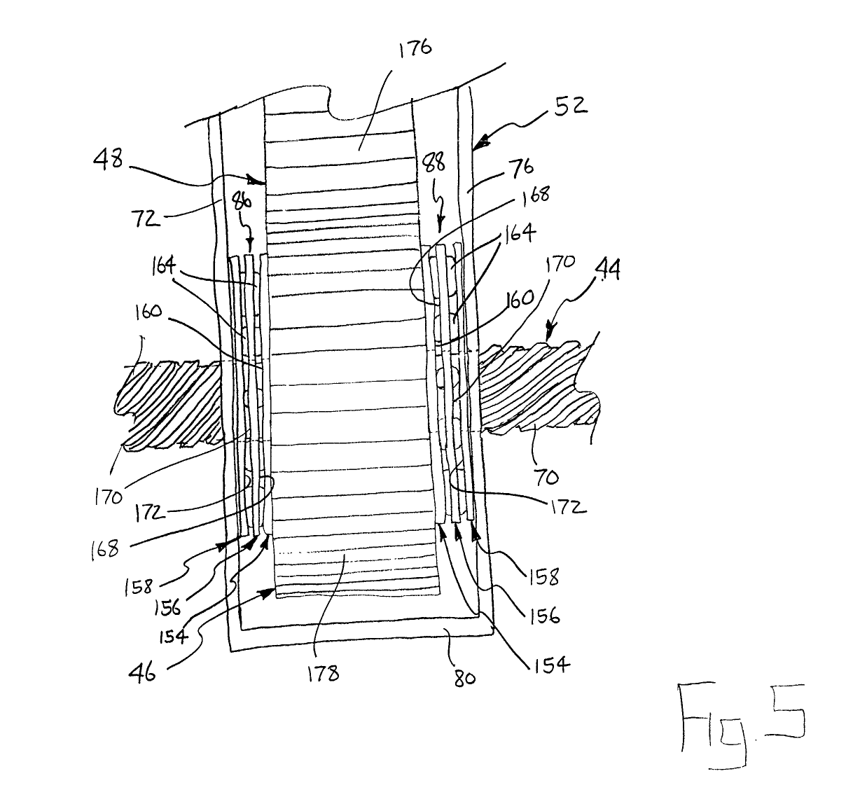

Referring now to FIGS. 4 and 5, drive gear 46 and mating gear 48 are shown mounted within drive housing 52. Drive gear 46 includes a central opening 180 having a plurality of internal threads 182 which are designed to correspond with external threads 70 of drive rod 44. Drive gear 46 is sandwiched between thrust bearings 86, 88 which are also mounted between side walls 72, 76 of drive housing 52. Each thrust bearing 86, 88 includes a first washer 154 which is mounted in contact with drive gear 46, a second washer 156 which is mounted adjacent washer 154, and a third washer 158 which is mounted adjacent second washer 156. First washer 154 includes a hardened, smooth surface 160 and an opening 162 for receiving drive rod 44. Second washer 156 includes a plurality of bearings 164 and a central opening 166 for receiving drive rod 44. Each bearing 164 is mounted for rotation about its axis, extends radially from the center of second washer 156, and projects from side surfaces 168, 170 as best shown in FIG. 5. Third washer 158 also includes a hardened, smooth surface 172 facing second washer 156, and a central opening 174 for receiving drive rod 44. As should be apparent to one skilled in the art, any of a variety of commonly available thrust bearing configurations could be used consistent with the teachings of the present invention.

As best shown in FIG. 5, thrust bearings 86, 88 are mounted between side walls 72, 76 of drive housing 52 with minimal clearance between the side walls and drive gear 46. Mating gear 48 is mounted within drive housing 52 such that the plurality of teeth 176 of mating gear 48 mesh with the plurality of teeth 178 of drive gear 46.

FIG. 4 also shows an alternate shaft 50′ which includes a first segment 184 connected to pinion 92 and a second segment 186 connected to pinion 96. First segment 184 includes a pair of aligned openings 188 for receiving a locking rod 190. Second segment 186 also includes a pair of aligned openings 192 for receiving a locking rod 194. Shaft 50′ also includes a coupler 195 which connects first segment 184 and second segment 186. Coupler 195 extends through openings 82 of drive housing 52 and a central opening 196 formed in mating gear 48. Central opening 196 includes a notch 197 for cooperating with coupler 195 as described below.

Coupler 195 includes cylindrical body 198 sized to fit within central opening 196 of mating gear 48. Coupler 195 also includes a pair of bores 200, 202 sized to receive locking pins 190, 194, and a keyway 204 sized to receive a key 206. During assembly, key 206 is fitted within keyway 204 and coupler 195 is placed through central opening 196 such that key 206 aligns with notch 197. Next, locking pin 190 is passed through openings 188 and bore 200 to connect shaft segment 184 to coupler 195. Similarly, locling pin 194 is passed through openings 192 of shaft segment 186 and bore 202 of coupler 195 to connect shaft segment 186 to coupler 195. As such, when mating gear 48 rotates, notch 197 and key 206 cause rotation of coupler 195 and shaft segments 184, 186 to drive slide out room 12 between the extended and retracted positions as further described below.

In operation, slide out room 12 is retracted into vehicle 10 by providing hydraulic fluid from a pump (not shown) to a chamber (not shown) within drive cylinder 42 near end 68. As hydraulic fluid is pumped into cylindrical housing 60, piston 62 is extended from housing 60. As piston 62 is extended, drive rod 44 is extended into drive housing 52 and drive gear 46. In the embodiment shown in FIG. 3, anti-rotation bar 132 slides within slots 146, 148 of guide housing 130. Threads 70 of drive rod 44 mesh with threads 182 of drive gear 46 during this extension. Consequently, drive gear 46 rotates in a counterclockwise direction as viewed in FIG. 4. As should be apparent to one skilled in the art, a conventional ball screw configuration could readily be used instead of the meshing threads of drive rod 44 and drive gear 46.

When drive rod 44 is extended in this manner, force is transmitted to the right as viewed in FIG. 4 to drive gear 46. Thrust bearing 88 reduces the power loss of this longitudinal force by facilitating rotation of drive gear 46. Specifically, drive gear 46 is pushed toward first washer 154, which is pushed toward second washer 156. Second washer 156 is pushed toward third washer 158, which is pushed toward wall 76 of drive housing 52. Bearings 164 mounted within second washer 156 permit free rotation of second washer 156 relative to first washer 154 and third washer 158. Thus, drive gear 46, which engages first washer 154, rotates freely relative to drive housing wall 76 which engages third washer 158, thereby reducing the friction of rotational movement of drive gear 46.

As drive gear 46 rotates, teeth 178 of drive gear 46 mesh with teeth 176 of mating gear 48, thereby causing rotation of mating gear 48 in a clockwise direction as viewed in FIG. 4. As mating gear 48 rotates, shaft 50 of FIGS. 1-3, or shaft 50′ of FIG. 4, also rotates in a clockwise direction. Rotation of shaft 50 or 50′ causes simultaneous rotation of pinions 92, 96. As pinions 92, 96 rotate, pinion teeth 114, 122 mesh with teeth 116, 124 of racks 118, 126, respectively. Accordingly, inner tubes 34, 40 are moved laterally inwardly toward vehicle 10, thereby moving slide out room 12 toward the retracted position.

Slide out room 12 is extended by pumping hydraulic fluid into the chamber (not shown) of cylindrical housing 60 adjacent end 64. The fluid in the other chamber is forced out of cylinder housing 60 to a reservoir (not shown) as piston 62 is extended from cylindrical housing 60. As such, drive rod 44 is moved to the left as viewed in the figures. Threads 70 of drive rod 44 mesh with internal threads 182 of drive gear 46 causing clockwise rotation of drive gear 46 as viewed in the figures. Drive gear 46 is urged to the left as viewed specifically in FIG. 4 against thrust bearing 86. Thrust bearing 86 reduces the friction of rotational movement of drive gear 46 in the manner described above with reference to thrust bearing 88. As drive gear 46 rotates in a clockwise direction, teeth 178 of drive gear 46 mesh with teeth 176 of mating gear 48 and cause counterclockwise rotation of mating gear 48 and shaft 50 (or 50′). As shaft 50 (or 50′) rotates in a counterclockwise direction, pinions 92, 96 also rotate and interact with racks 118, 126, respectively. Accordingly, inner tubes 34, 40 extend from outer tubes 32, 38, respectively, and room 12 is moved toward the extended position.

As should be readily apparent to one of ordinary skill in the art, the drive mechanism of FIGS. 1-5 may be readily modified to drive a single extendable support 28, 30. Such a drive mechanism would eliminate shaft 50 and mating gear 48. For example, drive gear 46 could mesh directly with one of pinions 92, 96 to drive a single rack 118, 126 of a single extendable support 28, 30.

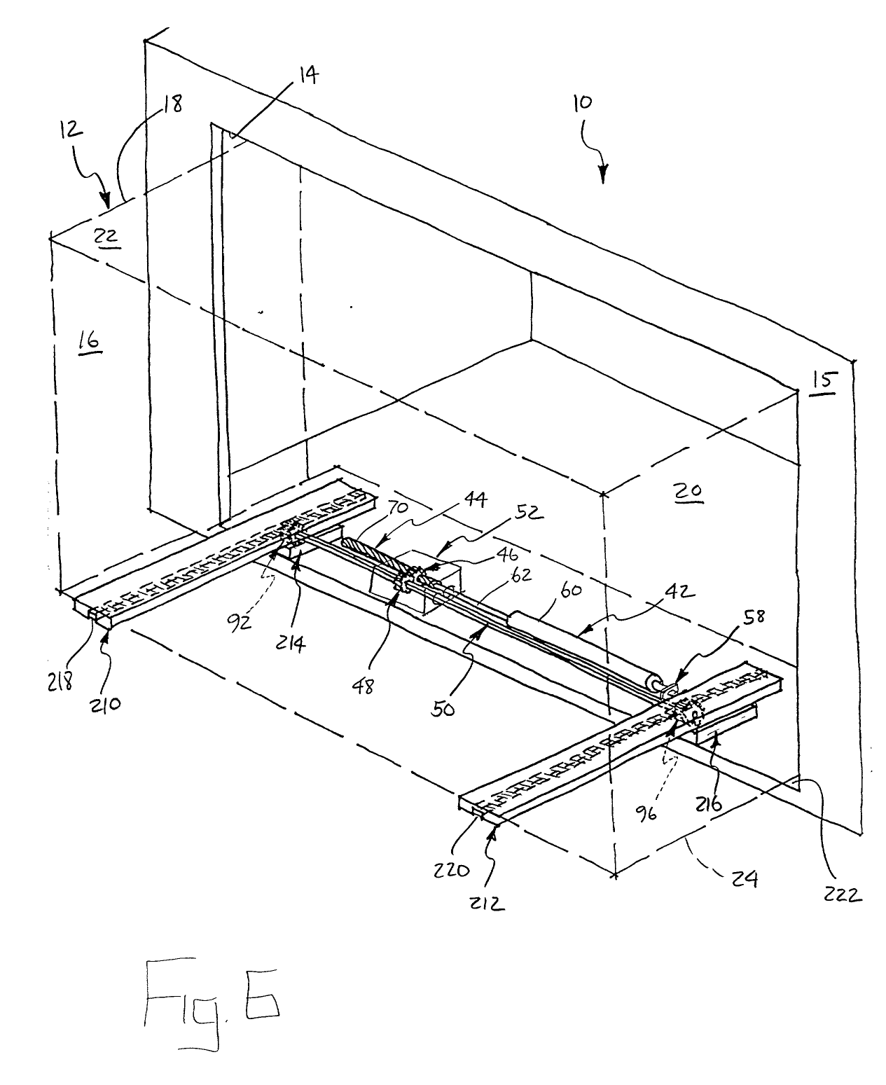

FIG. 6 shows an alternate embodiment of the drive mechanism of the present invention. In this embodiment, extendable supports 28, 30 are replaced with racks and guides. Specifically, rack 210 is mounted to room floor 24 adjacent side wall 22. Rack 212 is mounted to floor 24 adjacent side wall 20. Racks 210, 212 are mounted for lateral movement relative to vehicle 10 on guides 214, 216, respectively. Rack 210 includes a plurality of spaced teeth 218 aligned parallel relative to one another along the length of rack 210. Rack 210 is supported by guide 214 such as by rollers which fit within channels formed in rack 210 or other acceptable means for facilitating relatively low friction movement between rack 210 and guide 214 and preventing disengagement between rack 210 and guide 214 when, for example, room 12 is cantilevered out from vehicle 10 as shown in FIG. 6. Rack 212 also includes teeth 220 and is connected to guide 216 in a similar fashion.

Like the embodiment of the previous figures, drive cylinder 42 is disposed in perpendicular relationship to racks 210, 212, but is shown in FIG. 6 mounted to the floor 222 of vehicle 10 using bracket 58. Additionally, drive cylinder 42 and drive rod 44 are mounted in side-by-side relationship with shaft 50.

In operation, as piston 62 is extended from cylindrical housing 60, drive rod 44 is drawn through drive housing 52 and drive gear 46 such that drive gear 46 rotates in a clockwise direction. Mating gear 48, therefore, rotates in a counterclockwise direction, causing rotation of shaft 50 and pinions 92, 96 in a counterclockwise direction. Pinions 92, 96 mesh with teeth 218, 220 of racks 210, 212, respectively, thereby driving room 212 toward the extended position as shown in FIG. 6. When piston 62 is retracted within cylindrical housing 60, the process is reversed.

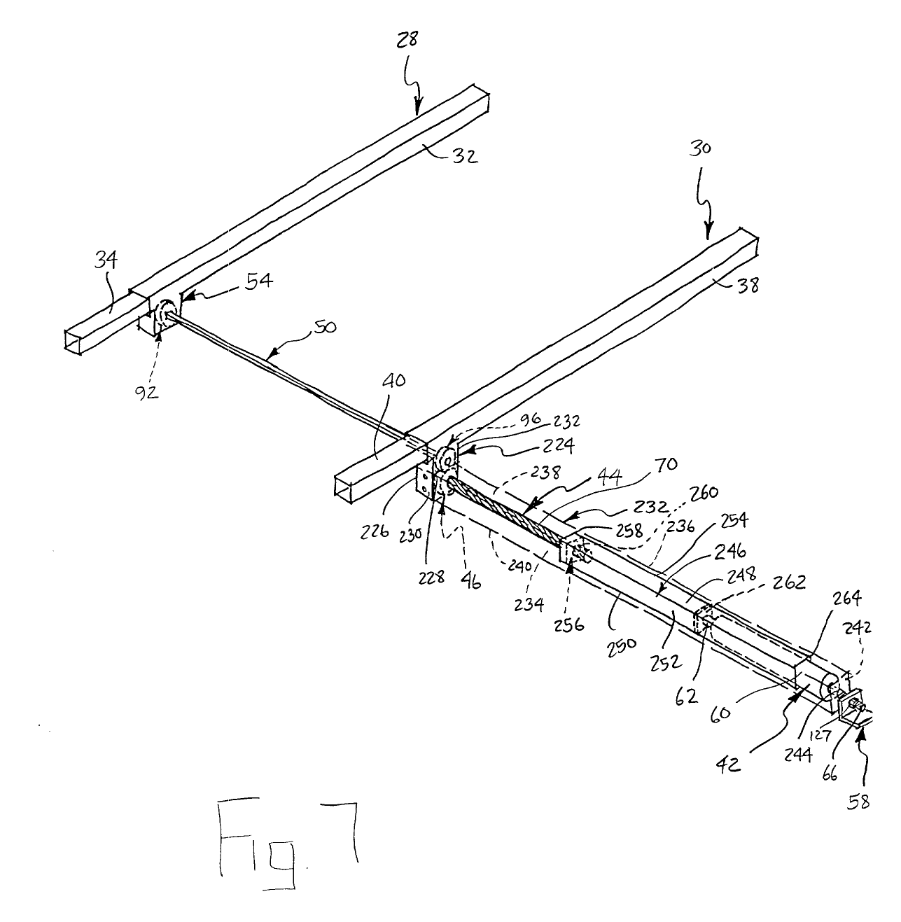

FIG. 7 shows an alternate embodiment of the drive mechanism according to the present invention. Extendable supports 28, 30 and drive shaft 50 are substantially the same as those described in FIGS. 1-5. In this embodiment, gear housing 56 is replaced with gear housing 224 and drive cylinder 42 and drive rod 44 are disposed in perpendicular relationship to extendable supports 28, 30, but not between extendable supports 28, 30.

Gear housing 224 includes a pair of side walls 226, 228, a front wall 230, and a rear wall 232. Pinion 96 is mounted for rotation between side walls 226, 228 in the manner described above. Drive gear 46 is mounted for rotation within gear housing 224 such that rotation of drive gear 46 in one direction causes rotation of pinion 96 in the opposite direction. Rod 44 is fixedly connected to drive gear 46.

A drive housing 232 extends from side wall 228 of gear housing 224. Drive housing 232 includes a pair of side walls 234, 236, an upper wall 238, a lower 240, and an end wall 242. Drive housing 232 encloses drive cylinder 42 and drive rod 44 as is further described below. End wall 242 of drive housing 232 includes an opening 244 through which extends threaded post 66 of drive cylinder 42. Threaded post 66 also extends through opening (not shown) in bracket 58 and is secured to bracket 58 using a nut 127. Bracket 58 is attached to the floor of the vehicle using fasteners (not shown) or some other suitable attachment mechanism.

An internal housing 246 extends between drive cylinder 42 and drive rod 44. Internal housing 246 includes an upper wall 248, a lower wall 250, and a pair of side walls 252, 254. A rectangular nut 256 is fixedly connected at one end 258 of internal housing 246. Nut 256 includes a central opening 260 having internal threads which mate with external threads 70 of drive rod 44. A rectangular plate 262 is also fixedly mounted within internal housing 246 approximately midway between end 258 and the opposed end 264. Cylindrical housing 60 of drive cylinder 42 extends into end 264 of internal housing 246. Piston 62 of drive cylinder 42 is fixedly connected to plate 262.

In operation, as piston 62 is extended from cylindrical housing 60, piston 62 urges plates 262 to the left as viewed in FIG. 7. Since plate 262 is fixedly connected to internal housing 246, internal housing 246 is moved to the left. Nut 256 is thereby driven over drive rod 44. The interaction between threads 70 on drive rod 44 and the internal threads (not shown) of nut 256 causes rotation of drive rod 44. As drive rod 44 rotates, drive gear 46 also rotates, causing movement of pinions 92, 96 of extendable members 28, 30, respectively, as described above. Slide out room 12 is thereby moved in one direction.

As piston 62 is retracted within cylindrical housing 60, nut 256 is pulled over threads 70 of drive rod 44, causing rotation of drive gear 46 in an opposition direction. This causes corresponding rotation of pinions 92, 96, thereby moving room 12 in the opposition direction.

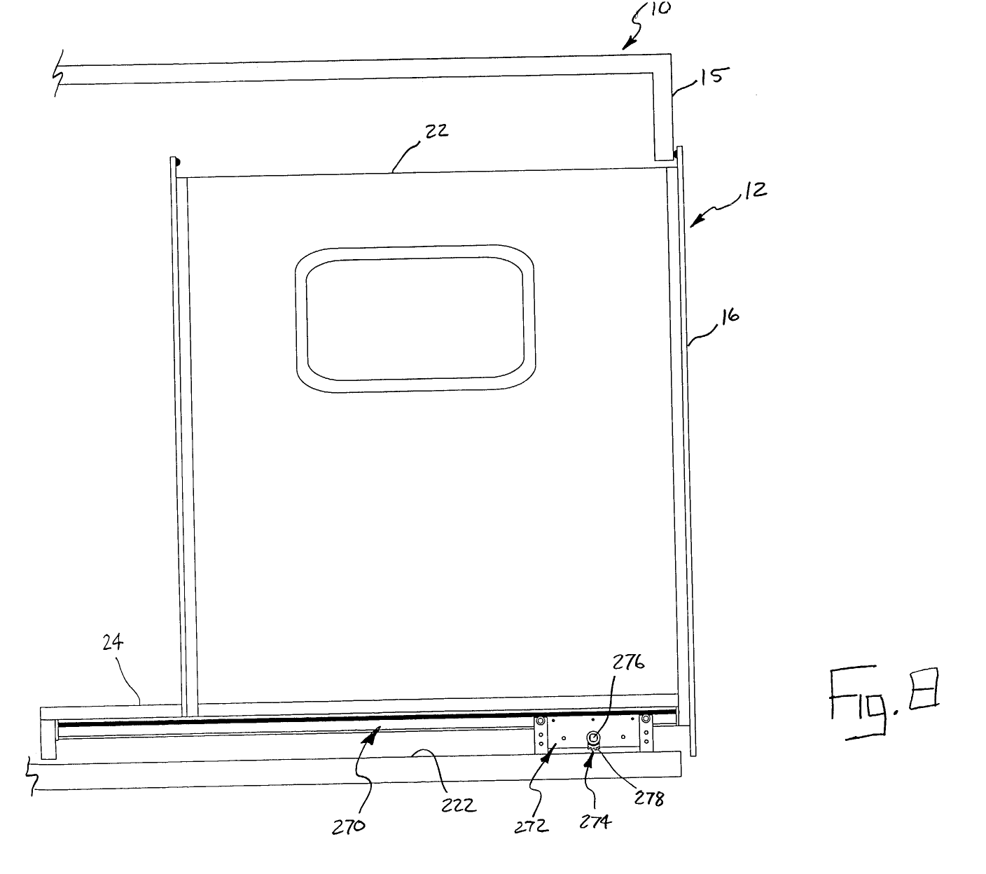

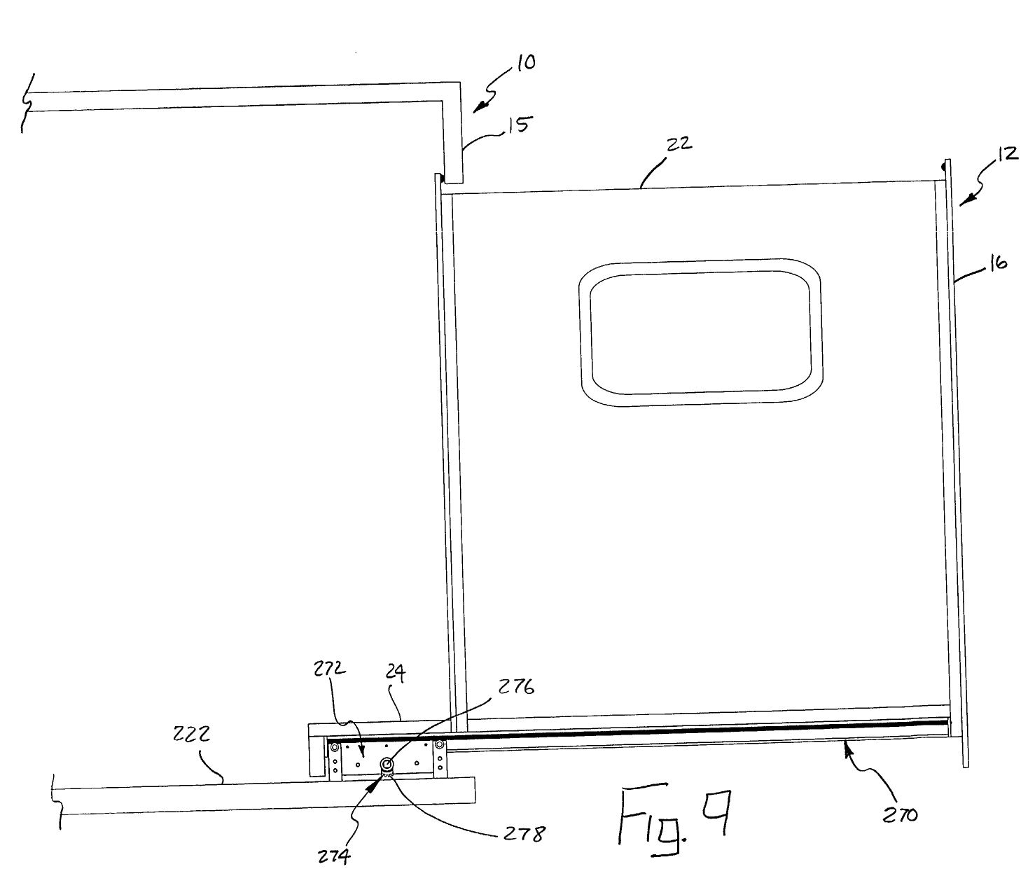

Referring now to FIGS. 8-11, a single rack and pinion support mechanism is shown in conjunction with a drive mechanism according to the present invention. As shown in FIGS. 8 and 9, a rack 270 is mounted to the lower surface of room floor 24 in the manner described with reference to FIG. 6. Rack 270 moves through guide 272 which is mounted to the floor 222 of vehicle 10. A pinion/thrust bearing assembly 274 is mounted within guide 272 for rotation about the central opening 276 of the pinion 278 of pinion/thrust bearing assembly 274.

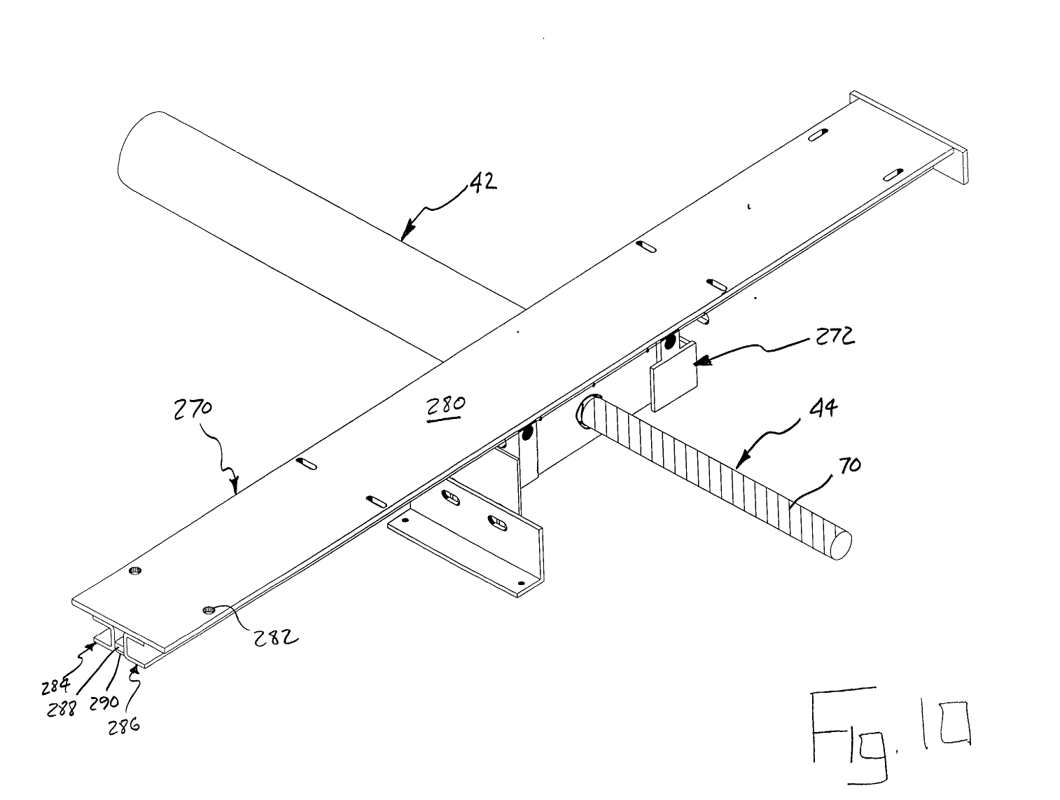

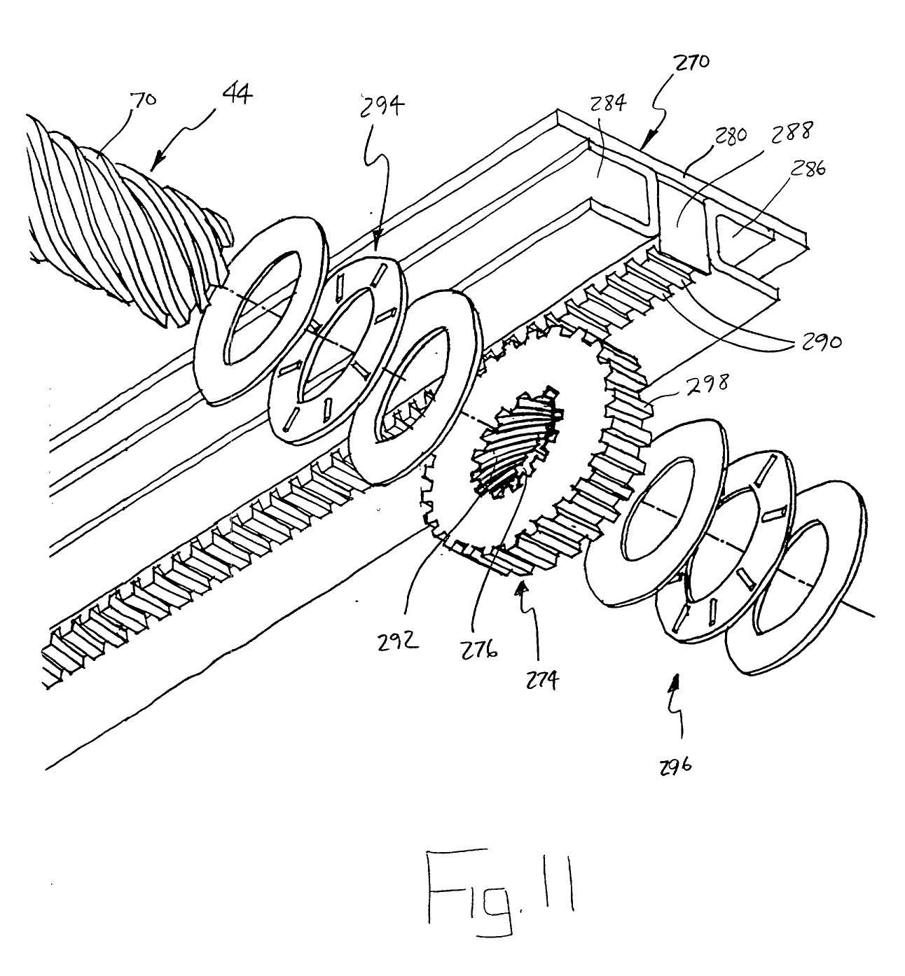

Referring now to FIG. 10, rack 270 includes a mounting plate 280 which includes a plurality of mounting holes 282 for receiving standard fasteners to mount rack 270 to the lower surface of room floor 24. Rack 270 further includes a pair of elongated channels 284, 286 joined together by a web 288 having a plurality of substantially parallel teeth 290 (FIG. 11). As room 12 is moved between the extended and retracted positions, rack 270 moves through guide 272. It should be understood that guide 272 could readily be mounted partially within floor 222 of vehicle 10. Rack 270 is supported for this linear movement by a pair of rollers (not shown) which ride within channel 284 on one side of guide 270, and a corresponding pair of rollers (not shown) which ride within channel 286 on the other side of guide 270. Power is provided for moving room 12 by drive cylinder 42 and drive rod 44.

Drive cylinder 42 is mounted to vehicle floor 222 using a bracket or other similar apparatus as described above. Piston 62 of drive cylinder 42 extends and retracts drive rod 44 which has external threads 70. As best shown in FIG. 11, pinion 278 includes a plurality of internal threads 292 within central opening 276. Pinion 278 and thrust bearings 294, 296 are included with pinion/thrust bearing assembly 274. The operation and mounting of thrust bearings 294, 296 is identical to that described in conjunction with FIGS. 4 and 5.

In operation, as piston 62 of drive cylinder 42 extends drive rod 44 through guide 272, external threads 70 of drive rod 44 mesh with internal threads 292 of pinion 274 causing rotation of pinion 274. Thrust bearings 294, 296 reduce the friction generated by translating the linear movement of drive rod 44 to the rotational movement of pinion 274. External teeth 298 of pinion 274 mesh with teeth 290 of rack 270 to move the rack, and room 12, toward either the extended position (FIG. 9) or the retracted position (FIG. 8). Room 12 is moved in an opposition direction by retracting piston 62 of drive cylinder 42 such that drive rod 44 moves in an opposition direction through pinion 274.

Of course, it should be understood that a pair of racks 270, a pair of guides 272 could readily be used according to the teachings above. Specifically, the pinions 274 of each such guide could be tied together by a shaft as described in conjunction with FIGS. 1-7 above. Additionally, drive rod 44 could drive a drive gear which would mesh with one of the pinions 274 of such guides. Alternatively, a drive gear could mesh with a mating gear mounted to the shaft to simultaneously rotate the pinions 274 of the guides in such a configuration.

Although the present invention has been shown and described in detail, the same is to be taken by way of example only and not by way of limitation. Numerous changes can be made to the embodiments described above without departing from the scope of the invention.

What is claimed is:

1. A drive mechanism for a slide out room of a recreational vehicle comprising actuation members actuable along an axis to extend and retract the slide out room relative to the vehicle, a transverse drive mechanism coupled to said actuation members and a drive member to drive said transverse drive mechanism.

2. The drive mechanism of claim 1, wherein said actuation members are linearly extensible members, with rack teeth positioned thereon.

3. The drive mechanism of claim 2, wherein said actuation members are coaxial tubes and a linear rack fixed to one of said tubes.

4. The drive mechanism of claim 2, wherein said transverse drive mechanism is a shaft having gears aligned with said rack, whereby said transverse drive mechanism is coupled to said racks through said gears.

5. The drive mechanism of claim 4, wherein said outer tubes include gear housings adjacent a front end thereof which retain said gears.

6. The drive mechanism of claim 4, wherein said drive member also extends in an axis substantially parallel with said transverse drive mechanism, and said drive member and said transverse drive mechanism, each include second gears to drive said transverse drive mechanism.

7. The drive mechanism of claim 6, wherein said drive member is a fluid operated cylinder having a piston driving a drive rod, wherein said drive rod is externally threaded, and said second gear associated with said externally threaded drive rod is internally threaded, whereby when said externally threaded drive rod is driven by said fluid operated cylinder, said second gear associated with said externally threaded drive rod is driven, which in turn drives said transverse drive mechanism.

8. The drive mechanism of claim 7, wherein said second gears are encased within a drive housing.

9. The drive mechanism of claim 7, wherein said fluid operated cylinder extends between said actuation members.

10. The drive mechanism of claim 7, wherein said fluid operated cylinder is laterally offset from said actuation members.

11. A drive mechanism for a slide out room of a recreational vehicle, comprising:
at least one actuation member actuable along an axis to extend and retract the slide out room relative to the vehicle;
a linear gear rack fixed to said actuation member in the direction of movement of the room;
a gear drive mechanism having an externally threaded drive section, an internally threaded drive section, cooperable with said externally threaded drive section, and an external gear section for mating engagement with said linear gear rack; and
a drive unit to drive said externally threaded drive section, which cooperates to drive said internally threaded drive section, and in turn said external gear section and said linear gear rack.

12. The drive mechanism of claim 11, wherein said gear drive mechanism further comprises a transverse drive shaft, wherein said external gear section is defined as a first gear mounted to said transverse drive shaft.

13. The drive mechanism of claim 12, wherein said transverse drive shaft further comprises a second gear mounted at an opposite end of said transverse drive shaft.

14. The drive mechanism of claim 13, wherein said transverse drive shaft has a third gear mounted intermediate said first and second gears.

15. The drive mechanism of claim 14, wherein said internally threaded drive section is positioned on an internal bore of a fourth gear member, said fourth gear member being in driving contact with said third gear member.

16. The drive mechanism of claim 15, wherein said externally threaded drive section is profiled as an externally threaded drive rod.

17. The drive mechanism of claim 15, wherein said drive unit is a fluid powered cylinder which actuates said externally threaded drive rod, which in turn drives said third gear, said transverse shaft and said first and second gears.

18. The drive mechanism of claim 17 wherein said third and fourth gear are mounted within a stationary gear box.

19. The drive mechanism of claim 16, further comprising a pair of actuation members, with said transverse drive shaft spanning between said actuation members.

20. The drive mechanism of claim 19, wherein said actuation members are linearly extensible members, with said rack teeth positioned thereon.

21. The drive mechanism of claim 20, wherein said actuation members are coaxial tubes and a linear rack fixed to one of said tubes.

22. The drive mechanism of claim 21, wherein said outer tubes include gear housings adjacent a front end thereof which retain said gears.

23. The drive mechanism of claim 21, wherein said drive member also extends in an axis substantially parallel with said transverse drive mechanism, and said drive member and said transverse drive mechanism.

24. The drive mechanism of claim 23, wherein said fluid operated cylinder extends between said actuation members.

25. The drive mechanism of claim 23, wherein said fluid operated cylinder is laterally offset from said actuation members.

26. A drive mechanism for a slide out room of a recreational vehicle, comprising at least one actuation member actuable along an axis to extend and retract the slide out room relative to ihe vehicle, and further comprising at least one actuation member having a linear gear rack fixed to said actuation member in the direction of movement of the room, and transverse drive means is provided to drive said at least one actuation member.

27. The drive mechanism of claim 26, wherein said transverse drive means is comprised of a gear drive mechanism having an externally threaded drive section, an internally threaded drive section, cooperable with said externally threaded drive section, and an external gear section for mating engagement with said linear gear rack; and a drive unit to drive said externally threaded drive section, which cooperates to drive said internally threaded drive section, and in turn said external gear section and said linear gear rack.

28. The drive mechanism of claim 27, wherein in that said gear drive mechanism further comprises a transverse drive shaft, wherein said external gear section is defined as a first gear mounted to said transverse drive shaft.

29. The drive mechanism of claim 28, wherein said transverse drive shaft further comprises a second gear mounted at an opposite end of said transverse drive shaft.

30. The drive mechanism of claim 29, wherein said transverse drive shaft has a third gear mounted intermediate said first and second gears.

31. The drive mechanism of claim 30, wherein said internally threaded drive section is positioned on an internal bore of a fourth gear member, said fourth gear member being in driving contact with said third gear member.

32. The drive mechanism of claim 31, wherein said externally threaded drive section is profiled as an externally threaded drive rod.

33. The drive mechanism of claim 32, wherein said drive unit is a fluid powered cylinder which actuates said externally threaded drive rod, which in turn drives said third gear, said transverse shaft and said first and second gears.

34. The drive mechanism of claim 33, wherein said third and fourth gears are mounted within a stationary gear box.

35. The drive mechanism of claim 34, further comprising a pair of actuation members, with said transverse drive shaft spanning between said actuation members.

36. The drive mechanism of claim 35, wherein said actuation members are linearly extensible members, with said rack teeth positioned thereon.

37. The drive mechanism of claim 36, wherein said actuation members are coaxial tubes and a linear rack fixed to one of said tubes.

38. The drive mechanism of claim 21, wherein said outer tubes include gear housings adjacent a front end thereof which retain said gears.

39. The drive mechanism of claim 21, wherein said drive member also extends in an axis substantially parallel with said transverse drive mechanism, and said drive member and said transverse drive mechanism.

40. The drive mechanism of claim 21, wherein said fluid operated cylinder extends between said actuation members.
